(19) United States
(12) Patent Application Publication
(10) Pub. No.: US 2005/0157515 A1
(43) Pub. Date: Jul. 21, 2005

(54) Light emitting diode light source

(76) Inventors: Wen-Ho Chen, Hsin Chu City (TW); Hui Yen Huang, Hsin Chu City (TW); King Chang Chang, Hsin Chu City (TW); Chia-Feng Lin, Tai Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/760,281

(22) Filed: Jan. 21, 2004

(51) Int. Cl. F21V 7/04

(52) U.S. Cl. 362/555

(57) ABSTRACT

A light emitting diode light source has a printed circuit board with a plurality of side faces, a plurality of RGB LED units arranged on one side face of the printed circuit board and each having a red LED, a green LED and a blue LED, and at least one control unit connected to each LED in the RGB LED units and controlling a driving current to the LED. Each of the RGB LED units emits a white light with stable color temperature. The control unit has a memory for storing a driving current data for each LED.

### FIELD OF THE INVENTION

The present invention relates to a light emitting diode light source, and especially to a light emitting diode light source emitting white light with a stable color temperature and capable of overcoming process variation.

### BACKGROUND OF THE INVENTION

Compact white light sources are extensively used for a backlight module of a scanner or color panel display. Therefore, the improvement for white light sources is also great issue for these industries.

FIG. 1 shows an exploded view of an edge backlight module 10, which comprises a panel light guide 100, a lamp 102 on one side of the panel light guide 100, a lamp reflecting plate 104 on outer side of the lamp 102, and a reflecting plate 106 on bottom of the panel light guide 100. The edge backlight module 10 further comprises a prism and light diffusing plates (not shown). The edge backlight module 10 can be used for a panel display and the lamp 102 can be a CCFL for emitting white light. The light emitted from the lamp 102 is reflected by the lamp reflecting plate 104 and then guided by the panel light guide 100, the prism and the light diffusing plate for forward emission. The forward emission can provide backlight for an LCD device. However, the CCFL has following problems: (1) complicated circuit design due to high driving voltage; (2) unstable illumination that changes with temperature; (3) dead zones present at both ends of the lamp. When the edge backlight module 10 is used for a scanner, the scanning quality is degraded due to the suboptimal qualities mentioned here.

The rapid progress in LED technologies now makes it possible to replace the CCFL with an LED, and the white LED can be provided in the following two ways:
(1) A blue LED is used with yellow phosphor, the illumination efficiency thereof being influenced by the phosphor.
(2) Red, green and blue LEDs are used together to mix a white light. The color temperature of this white LED may be unstable due to process variation of the LEDS.

### SUMMARY OF THE INVENTION

It is an object of the present invention to provide a light emitting diode light source emitting white light of stable color temperature or other colored light with stable color for overcoming fabrication variation of LEDs.

To achieve this object, the present invention to provide a light emitting diode light source comprising a printed circuit board with a plurality of side faces, a plurality of RGB LED units arranged on one side face of the printed circuit board, each having a red LED, a green LED and a blue LED and at least one control unit connected to each LED in the RGB LED units and controlling a driving current to the LED. Each of the RGB LED units emits a white light with stable color temperature.

Moreover, the control unit may have a memory such as EEPROM for storing a driving current data for each LED. The printed circuit board is made of material of good thermal conductivity such as Cu and Al.

### BRIEF DESCRIPTION OF DRAWING

The accompanying drawings are included to provide a further understanding of the invention, and are incorporated in and constitute a part of this specification. The drawings illustrate embodiments of the invention and, together with the description, serve to explain the principles of the invention.

FIG. 1 shows an exploded view of a prior art edge backlight module;

FIG. 2 shows a perspective view of the light emitting diode light source according to the present invention;

FIG. 3A shows a top view of the light emitting diode light source according to the present invention;

FIG. 3B shows a top view of the light emitting diode light source according to the present invention;

FIG. 4 shows a top view of the RGB LED unit according to the present invention;

FIG. 5A shows a top view of the light emitting diode light source according to the second preferred embodiment of the present invention;

FIG. 5B shows a top view of the light emitting diode light source according to the third preferred embodiment of the present invention; and

FIG. 6 shows a bottom view of the light emitting diode light source according to the second preferred embodiment of the present invention.

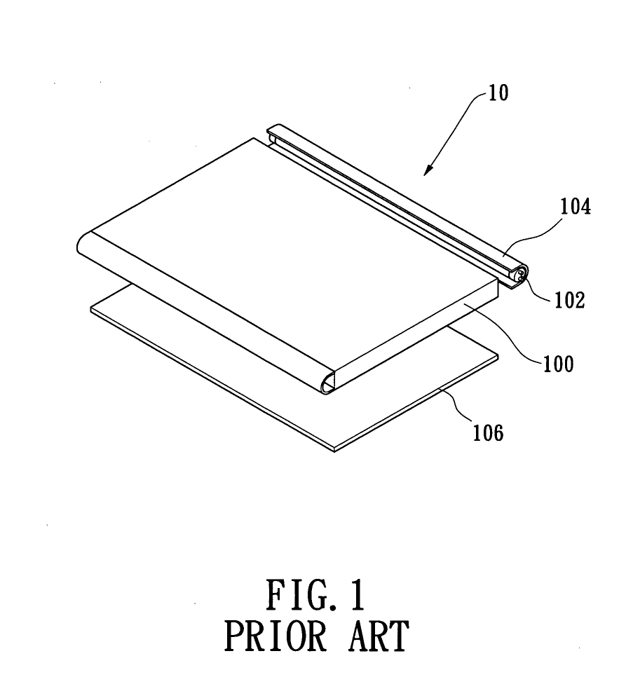

### DETAILED DESCRIPTION OF THE INVENTION

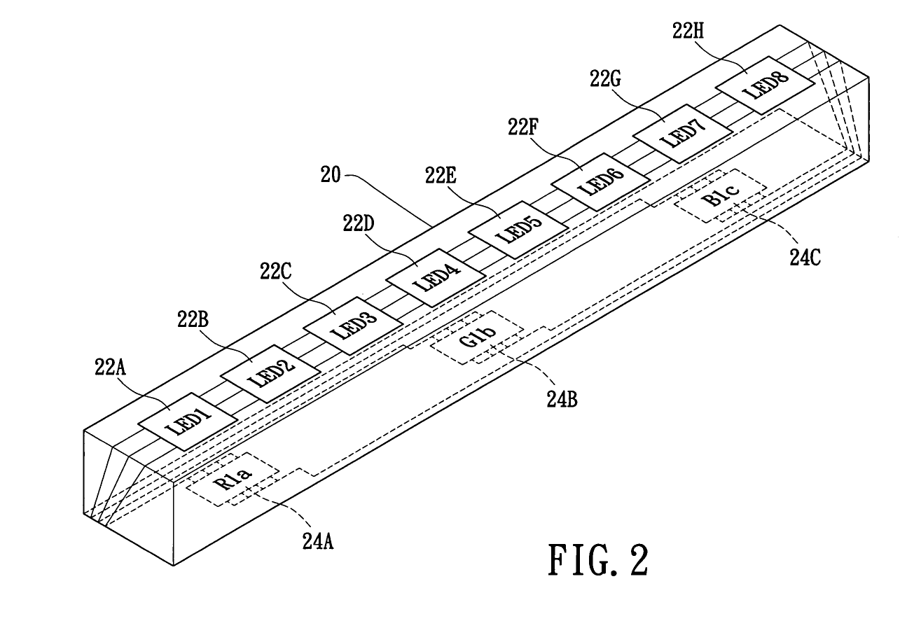

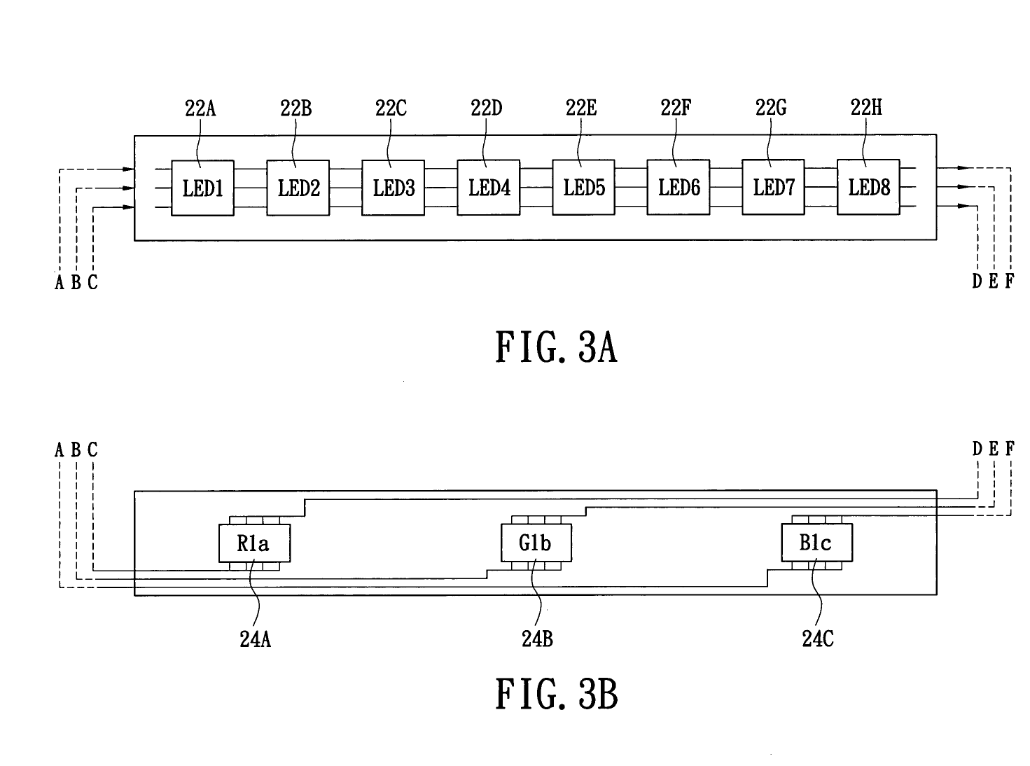

FIG. 2, FIGS. 3A and 3B show the perspective view, top view and bottom view of the light emitting diode light source according to the present invention. As shown in FIG. 2, the light emitting diode light source 2 according to the present invention mainly comprises a printed circuit board 20, a plurality of RGB LED units 22A-22H, and at least one control unit 24A-24C. The printed circuit board 20 is of elongated shape and has opposite front and back faces, opposite lateral faces and opposite end faces. The plurality of RGB LED units 22A-22H is located at the front face of the printed circuit board 20, and the control unit 24A-24C is located at any face of the printed circuit board 20. In this figure, the control unit 24A-24C is located at the back face of the printed circuit board 20. It should be noted that the control unit 24A-24C could be located at other faces of the printed circuit board 20. The printed circuit board 20 is preferably made of a material with good thermal conductivity such as an Al or Cu substrate.

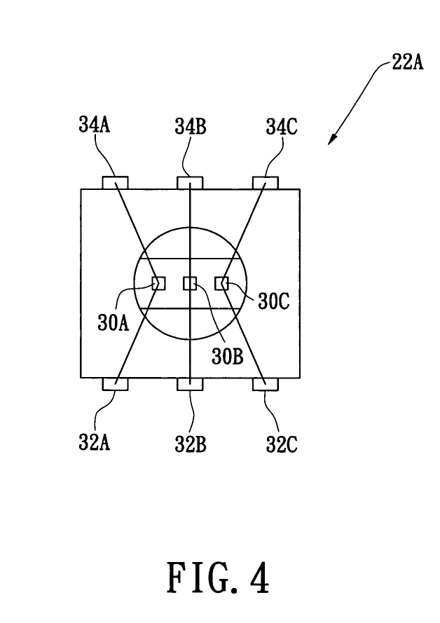

As shown in FIG. 3A, in this preferred embodiment, the light emitting diode light source 2 according to the present invention further mainly comprises eight sets of RGB LED unit 22A-22H with identical structure. As shown in FIG. 4, taking the RGB LED unit 22A as an example, the RGB LED unit 22A comprises a base (not labeled), and red LED 30A, green LED 30B and blue LED 30C mounted on the base, respectively. The anode and cathode of the red LED 30A are connected to pads 32A and 34A through conductive wires. The anode and cathode of the green LED 30B are connected to pads 32B and 34B through conductive wires. The anode and cathode of the blue LED 30C are also connected to pads 32C and 34C through conductive wires.

As shown in FIG. 3B, in this preferred embodiment, the light emitting diode light source 2 according to the present invention mainly further comprises three sets of control units 24A-24C on a back face of the printed circuit board 20. The control unit 24A controls a driving current for the eight red LEDs and has eight pins connected to anode pad or cathode pad (such as 32A or 34A) of the red LEDs of the RGB LED units 22A-22H. The control unit 24B controls a driving current for the eight green LEDs and has eight pins connected to anode pad or cathode pad (such as 32B or 34B) of the green LEDs of the RGB LED units 22A-22H. The control unit 24C controls a driving current for the eight blue LEDs and has eight pins connected to anode pad or cathode pad (such as 32C or 34C) of the blue LEDs of the RGB LED units 22A-22H. The illumination of the red, green and blue LEDs in the eight sets of the RGB LED units 22A-22H are controlled by the three sets of control unit 24A-24C. Therefore, the color temperature of the light emitting diode light source 2 can be controlled. Moreover, the control unit 24A-24C can be either in serial or in parallel with the RGB LED units 22A-22H.

More particularly, the RGB LED units 22A-22H will not have the same color temperature if the driving condition is the same, because the LED may have fabrication variation. A calibration process can be executed on each LED through contact thereof when the RGB LED units 22A-22H are assembled and the characteristic data of the LED is stored in memory (not shown; can be, for example, EEPROM) of the control unit 24A-24C. When lighting the light emitting diode light source 2, the control unit 24A-24C controls the driving condition of each LED by reading the characteristic data stored in memory. Moreover, the control unit 24A-24C can be implemented into the controller IC to controls the driving condition of each LED by reading an external command, whereby the color temperature of the light emitting diode light source 2 can be controlled.

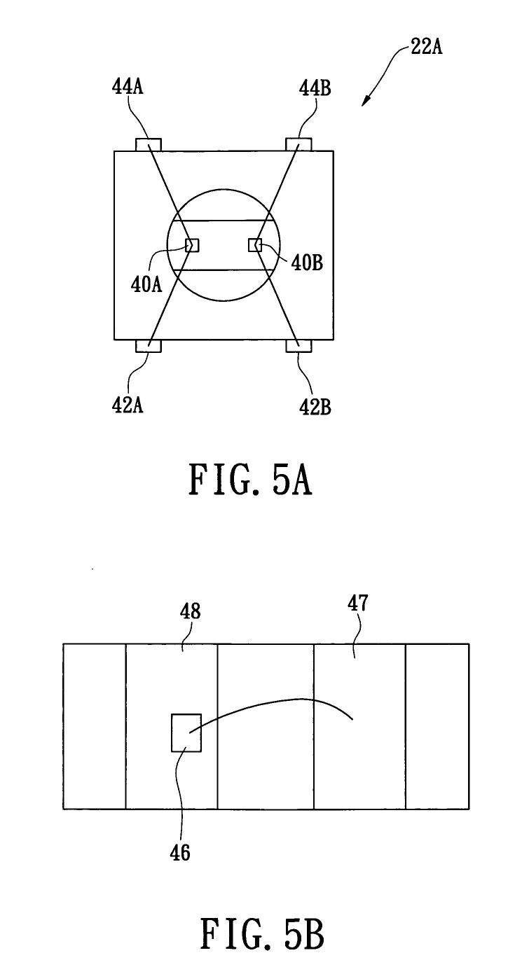

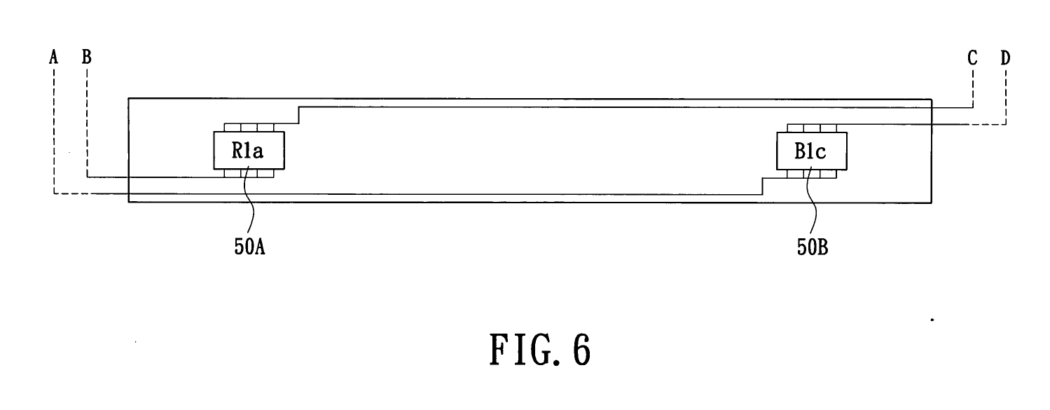

FIG. 5A shows the light emitting diode light source according to another preferred embodiment of the present invention. In this preferred embodiment, the plurality of RGB LED units 22A-22H is replaced by bi-color LED units. The bi-color LED units comprise at least one first LED 40A and at least second LED 40B with different color to the first LED 40A. As shown in FIG. 5A, the first LED 40A is connected to pads 42A and 44A through conductive wires, and the second LED 40B is connected to pads 42B and 44B through conductive wires. With reference to FIG. 6, the light emitting diode light source according to this preferred embodiment of the present invention further comprises at least one control unit 50A and 50B. The control unit 50A and SOB is electrically connected to the pads 42A and 44A of the first LED 40A and the pads 42B and 44B of the second LED 40B, respectively. The first LED 40A and the second LED 40B are driven by the control unit 50A and 50B according to pre-stored characteristic data stored in memory. Therefore, the color temperature of the light emitting diode light source can be controlled.

FIG. 5B shows the light emitting diode light source according to still another preferred embodiment of the present invention. In this preferred embodiment, the plurality of RGB LED units 22A-22H is replaced by mono-colors LED units. The mono-colors LED units comprise at least one LED 46. The LED 46 is connected to pads 47 and 48 through conductive wires, whereby the LED 46 is driven by a control unit (not shown) according to pre-stored characteristic data stored in memory. Therefore, the color temperature of the light emitting diode light source can be controlled.

To sum up, the light emitting diode light source according to the present invention can emit white light of stable color temperature or another color light with stable color. However, the scope of the present invention is not limited to the above special cases and has other variations. For example, the number of the RGB LED units is not limited to eight and the number of the control unit corresponds to that of the RGB LED units.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A light emitting diode light source, comprising:
a printed circuit board with a plurality of side faces;
a plurality of RGB LED units arranged on one side face of the printed circuit board, each LED unit having a red LED, a green LED and a blue LED;
at least one control unit connected to each LED in the RGB LED units and controlling a driving current to the LED, whereby each of the RGB LED units emits a white light with stable color temperature.

2. The light emitting diode light source as in claim 1, wherein the LED has an anode and a cathode connected to two pads on each of the RGB LED units, and the pads are electrically connected to corresponding control unit.

3. The light emitting diode light source as in claim 1, wherein the control unit has a memory for storing driving current data for each LED.

4. The light emitting diode light source as in claim 1, wherein the control unit is a control IC.

5. The light emitting diode light source as in claim 1, wherein the printed circuit board is made of a material of good thermal conductivity.

6. The light emitting diode light source as in claim 5, wherein the printed circuit board is made of Al.

7. The light emitting diode light source as in claim 5, wherein the printed circuit board is made of Cu.

8. The light emitting diode light source as in claim 1, wherein the control unit comprises a red-light control unit connected to a red LED, a green-light control unit connected to a green LED and a blue-light control unit connected to a blue LED.

9. The light emitting diode light source as in claim 8, wherein the red-light control unit connected to the red LED, the green-light control unit and the blue-light control unit have pin numbers identical to a pin number of the RGB LED unit.

10. The light emitting diode light source as in claim 8, wherein the red-light control unit connected to the red LED, the green-light control unit and the blue-light control unit have pin numbers larger than the pin number of the RGB LED unit.

11. The light emitting diode light source as in claim 1, wherein the control unit is connected in parallel with a corresponding LED.

12. The light emitting diode light source as in claim 1, wherein the control unit is connected in series with a corresponding LED.

13. The light emitting diode light source as in claim 1, wherein the control unit has at least three pins for controlling a driving current for the red LED, the green LED and the blue LED.

14. A light emitting diode light source, comprising:
a printed circuit board with a plurality of side faces;
a plurality of LED units arranged on one side face of the printed circuit board and each having a first LED with a first color and a second LED with a second color different from the first color;
at least one control unit connected to each LED in the LED units and controlling a driving current to the LED, whereby each of the LED units emits a light with stable color.

15. The light emitting diode light source as in claim 14, wherein the LED has an anode and a cathode connected to two pads on each of the LED units, and the pads are electrically connected to a corresponding control unit.

16. The light emitting diode light source as in claim 14, wherein the control unit has a memory for storing a driving current data for each LED.

17. The light emitting diode light source as in claim 14, wherein the control unit is a control IC.

18. The light emitting diode light source as in claim 14, wherein the printed circuit board is made of a material of good thermal conductivity.

19. The light emitting diode light source as in claim 18, wherein the printed circuit board is made of Al.

20. The light emitting diode light source as in claim 18, wherein the printed circuit board is made of Cu.

21. The light emitting diode light source as in claim 14, wherein the control unit is connected in parallel with a corresponding LED.

22. The light emitting diode light source as in claim 14, wherein the control unit is connected in series with a corresponding LED.

23. The light emitting diode light source as in claim 1, wherein the control unit has at least two pins for controlling a driving current for the first LED and the second LED.

24. A light emitting diode light source, comprising:
a printed circuit board with a plurality of side faces;
a plurality of LED units arranged on one side face of the printed circuit board and each having an LED;
at least one control unit connected to each LED in the LED units and controlling a driving current to the LED, whereby each of the LED units emits a light with stable color.

25. The light emitting diode light source as in claim 24, wherein the LED has an anode and a cathode connected to two pads on each of the LED units, and the pads are electrically connected to a corresponding control unit.

26. The light emitting diode light source as in claim 24, wherein the control unit has a memory for storing a driving current data for each LED.

27. The light emitting diode light source as in claim 24, wherein the control unit is a control IC.

28. The light emitting diode light source as in claim 14, wherein the printed circuit board is made of a material of good thermal conductivity.

29. The light emitting diode light source as in claim 28, wherein the printed circuit board is made of Al.

30. The light emitting diode light source as in claim 28, wherein the printed circuit board is made of Cu.
